(19) United States
(12) Patent Application Publication
(10) Pub. No.: US 2013/0108301 A1
(43) Pub. Date: May 2, 2013

(54) INPUT DEVICE OF IMAGE FORMING APPARATUS AND IMAGE FORMING APPARATUS

(71) Applicants: Norihide MOMOSE, Osaka-shi (JP); Kenji SUGIMURA, Osaka-shi (JP)

(72) Inventors: Norihide MOMOSE, Osaka-shi (JP); Kenji SUGIMURA, Osaka-shi (JP)

(21) Appl. No.: 13/660,795

(22) Filed: Oct. 25, 2012

(30) Foreign Application Priority Data
Oct. 26, 2011 (JP) 2011-234915

(51) Int. Cl. G03G 15/00

(52) U.S. Cl. 399/81

(57) ABSTRACT

An input device of an image forming apparatus is provided with a panel portion, which has a display portion and by which input is carried out by a user touching the display portion, and in which at least one portion is displaced according to touch by the user, and at least one switch portion by which input is carried out by an operation according to displacement exceeding a preset displacement amount of the panel portion. Input by the input device includes a first input, which is input carried out using only the panel portion, and a second input, which is input carried out using the panel portion and the switch portion.

This application claims priority under 35 U.S.C. §109(a) on Patent Application No. 2011-234915 filed in Japan on Oct. 26, 2011, the entire contents of which are hereby incorporated by reference.

### BACKGROUND OF THE INVENTION

The present invention relates to input devices of image forming apparatuses and image forming apparatuses.

Image forming apparatuses (for example multifunction peripherals (MFP)) that form an image on a recording paper are available as image processing apparatuses, which are electronic devices. These image forming apparatuses are provided with multiple basic operational modes such as a copy mode, fax mode, printer mode, and scanner mode.

The image forming apparatus forms an electrostatic latent image on a photosensitive member such as a photosensitive drum or the like by performing optical modulation and irradiation of a laser beam according to image data, then develops the electrostatic latent image that has been formed on the photosensitive member using a toner, thereby forming a toner image on a transfer member such as an intermediate transfer belt (for example, see JP 2003-149907A (hereinafter referred to as patent document 1)).

The image forming apparatus described in patent document 1 is provided with multiple image forming portions corresponding to each color of multiple colors, and an image of each color is superimposed and transferred onto an endless belt (transfer member) from the multiple image forming portions, after which the superimposed transferred image is transferred as a whole onto the recording paper to form a color image on the recording paper.

In this regard, these image forming apparatuses use an operation panel such as a touch panel and task switches such as keys (for example a start key) as an operation portion for a user to perform input. In particular, currently the UIs (user interfaces) of operation panels have become graphical and mainstream input portions are changing from tactile switches to operation panels.

The operation panels that are commonly used at present have an operational function by which users carry out input of various instructions and a display function of displaying various types of information, and function as an interface between the image forming apparatus and the user. By using an operation panel in which the display function and the operational function are combined as an input portion rather than only an operation function, there is the advantage that it is not necessary to provide the image forming apparatus with a separate display portion and operation portion.

When using an image forming apparatus provided with the above-mentioned operation panel, items (software buttons) are displayed on the operation panel for selecting operational modes in the image forming apparatus and the user who views this display presses the position of the item displayed on the operation panel (presses a software button) to set the operational mode.

However, unlike input using task switches, in the case of input using an operation panel, the input has no click sensation. Thus, it is difficult for a user who is using the operation panel to distinguish whether or not input has been performed without error.

Accordingly, to address this problem, an object of the present invention is to provide an input device of an image forming apparatus and an image forming apparatus in which an input click sensation can be achieved even for input using an operation panel.

### SUMMARY OF THE INVENTION

To achieve the above-described object, an input device of an image forming apparatus according to the present invention is provided with a panel portion having a display portion and by which input is carried by a user touching the display portion, and in which at least one portion is displaced according to touch by the user, and at least one switch portion by which input is carried out by an operation according to displacement exceeding a preset displacement amount of the panel portion, wherein input of the input device includes a first input, which is input carried out using only the panel portion, and a second input, which is input carried out using the panel portion and the switch portion.

With the present invention an input click sensation can be achieved even for input using the panel portion. In particular, with the present invention there is input by the input device includes a first input, which is input carried out using only the panel portion, and a second input, which is input carried out using the panel portion and the switch portion, and therefore input that requires a click sensation and input that does not require a click sensation can be carried out with a single input device, which increases the degree of freedom of the input device. Furthermore, since the first input and the second input can be used in combination, it is possible to differentiate input for commencing execution and operation relating to image forming and input for selecting operations other than these (for example, input of the number of copies of printing or the like), and by implementing an input click sensation in regard to only input for commencing execution and operation relating to important image forming, this is an effective means for the user in confirming execution and operation.

In the above-described configuration, the switch portion may be arranged directly below or near to directly below an input region of the second input of the display portion.

In this case, since the switch portion is arranged directly below or near to directly below an input region of the second input of the display portion, the second input can be carried out easily.

In the above-described configuration, the at least one of the switch portions may be provided at an edge area of the display portion, and the second input may be input using the panel portion and the switch portion that is provided at the edge area.

In this case, since the at least one of the switch portions is provided at an edge area of the display portion, and the input target of the second input is input using the panel portion and the switch portion that is provided at the edge area, the pressing force of the user in touching the display portion to carry out the second input can be reduced. This is related to the fact that the pressing force required to displace the panel portion by pressing the edge area is smaller than the pressing force required to displace the panel portion by pressing, for example, a central area of the panel portion.

In the above-described configuration, a stopper portion may be provided at the switch portion to protect the switch portion by restricting displacement of the panel portion closer toward the switch portion.

In this case, since the stopper portion is provided at the switch portion, displacement of the panel portion can be restricted by the stopper portion, which enables damage (cracking or the like) of the panel portion to be prevented. Furthermore, the force of the panel portion pressing the switch portions can be concentrated on the stopper portion such that breakage of the switch portion due to pressing of the panel portion can be suppressed.

To achieve the above-described object, an image forming apparatus according to the present invention is provided with an input device according to the present invention.

With the present invention, the operation and effect of the input device according to the present invention can be obtained.

### BRIEF DESCRIPTION OF THE DRAWINGS

FIG. 1 is an outline configuration view showing an overall configuration of an image forming apparatus according to the present embodiment, and is an outline cross-sectional view as viewed from the front.

FIG. 2 is an outline configuration block diagram showing main constitutional members of an image forming apparatus according to the present embodiment.

FIG. 3 is an outline configuration drawing showing each region of a display screen of a panel portion according to the present embodiment.

FIG. 4 is an outline configuration drawing showing relationships between each region and each item of the display screen of the panel portion according to the present embodiment.

FIG. 5 is an outline lateral view showing an overall configuration of an input device according to the present embodiment.

FIG. 6 is an outline top view showing an overall configuration of the input device according to the present embodiment.

FIG. 7 is an outline cross-sectional view showing an overall configuration of an input device according to another embodiment.

### DESCRIPTION OF REFERENCE NUMERALS

1 exposing unit
2 developer unit
3 photosensitive drum
4 photosensitive member unit
5 charging device
6 intermediate transfer belt unit
7 fixing unit
8 pre-transfer charging unit
10 transfer roller
11a, 11b pickup roller
12a, 12b, 12c, 12d transport roller
13 registration roller
21 toner cartridge unit
61 intermediate transfer belt
62 drive roller
63 idler roller
64 intermediate transfer roller
65 cleaning unit
71 heat roller
71a heater
71b temperature detector
72 pressure roller
73 external heating belt
81 paper feed tray
82 manual paper feed tray
90 optical unit
91 discharge tray
92 original placement platform
100 image forming apparatus
102 image forming portion
103 paper transport system
108 original reading device
110 apparatus main body
200 image forming unit
300 main control portion
301 input portion
302 display portion
303 storage portion
304 image processing computation portion
305 network
306 network interface
307 phone line
308 facsimile portion
309 bus
310 sensor portion
400 input device
410 panel portion
411 display portion
412 liquid crystal panel
413 touch panel
414 pass-through hole
415 lateral surface
416 outer circumferential edge
417 front surface
418 rear surface
420 display screen
421 system region
422 function region
423 display input region
424 action region
425 task trigger region
430 switch portion
431 pedestal portion
432 button portion
433 stopper portion
440 support prop
450 coupling portion
451 lateral wall portion
452 front wall portion
453 rear wall portion
454 pass-through hole
D1 first data
D2 second data
P1, P2, P3, P4 detection pattern
PB detection pattern block
S paper transport path

### DESCRIPTION OF THE PREFERRED EMBODIMENTS

Hereinafter, embodiments of the present invention are described with reference to the accompanying drawings.

Overall Configuration of Image Forming Apparatus

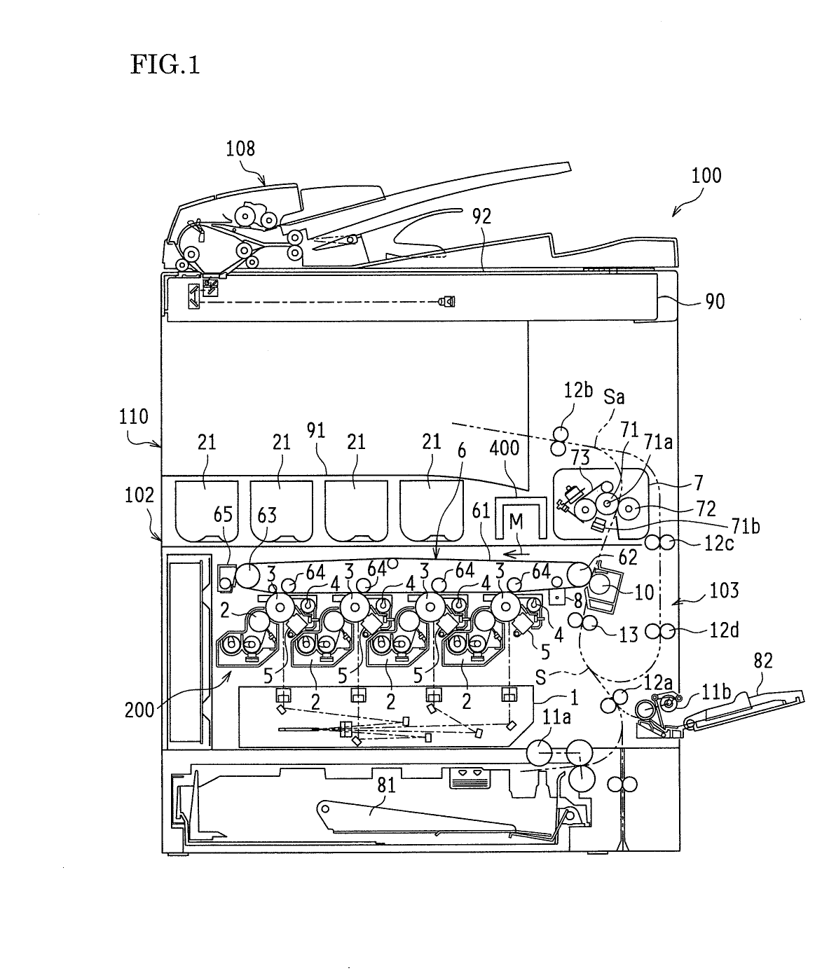

FIG. 1 is an outline front view showing an overall configuration of an image forming apparatus 100 according to the present embodiment, and is an outline cross-sectional view as viewed from the front.

The image forming apparatus 100 shown in FIG. 1 is a color image forming apparatus that forms an image constituted by at least one color or more (multicolor or single color) on a sheet (hereinafter referred to as recording paper) such as a recording paper according to image data for carrying out image forming.

The image forming apparatus 100 forms the image on the recording paper using an electrophotographic technique, and is provided with a copy mode, a facsimile mode, a document filing mode (a mode in which scanned images are stored in a storage portion 303 (see below) inside the image forming apparatus 100), an email mode (a mode in which a scanned image is sent as an attachment to an email), and a network printer mode and the like as operational modes. It should be noted that the operational modes of the image forming apparatus 100 are not limited to these and can be set arbitrarily.

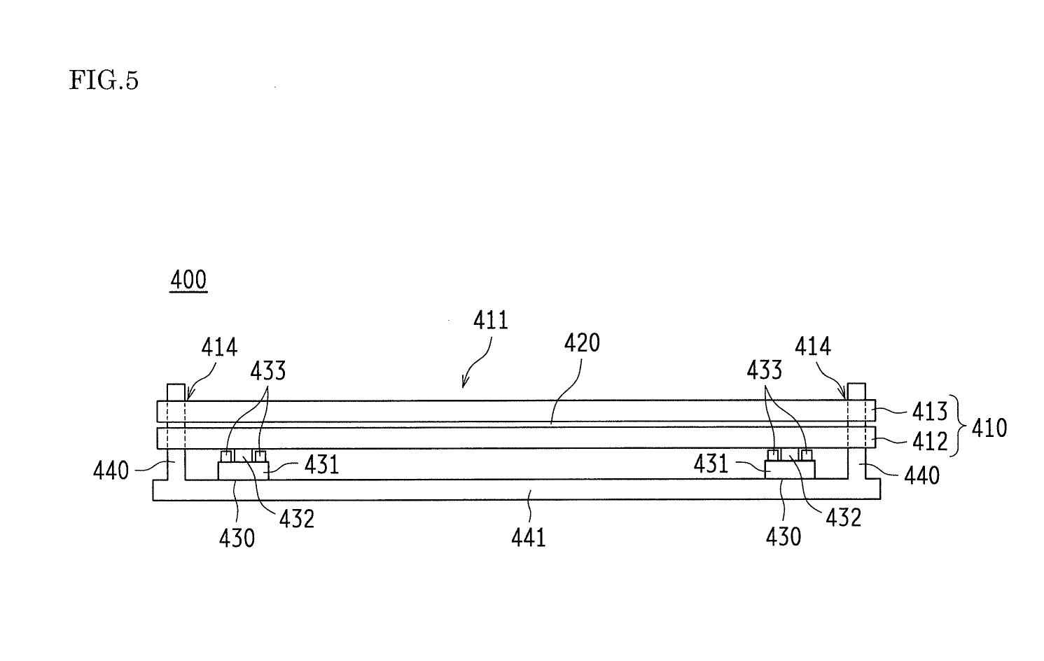

The image forming apparatus 100 is provided with an original reading device 108, an apparatus main body 110, and an input device 400 (see FIG. 5); and an image forming portion 102 and a paper transport system 103 are provided in the apparatus main body 110.

The image forming portion 102 is provided with an exposing unit 1, multiple developer units 2, multiple photosensitive member units 4, an intermediate transfer belt unit 6, a pre-transfer charging unit 8, multiple toner cartridge units 21, and a fixing unit 7. In the present embodiment, the exposing unit 1, the developer units 2, the photosensitive member units 4, the intermediate transfer belt unit 6, and the toner cartridge units 21 act as multiple image forming units 200 that have different image forming operations and are removable. It should be noted that here the photosensitive member units 4 are combinational units in which a photosensitive member unit, a charging unit, and a cleaning unit are integrated.

Furthermore, the paper transport system 103 is provided with a paper feed tray 81, a manual paper feed tray 82, and a discharge tray 91.

An original placement platform 92, which is constituted by a transparent glass on which a sheet such as an original (hereinafter referred to as an original) is placed, is provided at an upper portion of the apparatus main body 110, and an optical unit 90 for reading originals is provided below the original placement platform 92. Furthermore, an original reading device 108 is provided at an upper side of the original placement platform 92. The original reading device 108 is a device that automatically transports originals onto the original placement platform 92. Furthermore, the original reading device 108 is rotatably attached to the apparatus main body 110 such that its front side opens, and an original can be placed manually by opening the top of the original placement platform 92. It should be noted that in the present embodiment, the front side of the apparatus main body 110 is a removing side at which the toner cartridge units 21, the photosensitive member units 4, the developer units 2 and the pre-transfer charging unit 8 are removed and attached.

The original reading device 108 is capable of reading an original that is automatically transported over the original placement platform 92 or an original that is placed on the original placement platform 92. An entire image of the original that is read by the original reading device 108 is sent as image data to the apparatus main body 110 of the image forming apparatus 100, and an image that is formed based on this image data is recorded onto a recording paper in the apparatus main body 110.

Image data handled in the image forming apparatus 100 corresponds to a color image using multiple colors (here, each of the colors black (K), cyan (C), magenta (M), and yellow (Y)). Accordingly, multiple sets of the developer units 2, the photosensitive member units 4, and the toner cartridge units 21 are provided (here, four sets are provided for black, cyan, magenta, and yellow respectively) so as to form images of multiple types (here, four types) corresponding to the colors, thereby constituting an image station for each of these colors (here, four colors).

In the photosensitive member units 4, charging devices 5 are charging means for uniformly charging the surfaces of photosensitive drums 3 to a predetermined electric potential and in addition to charger type devices as shown in FIG. 1, contact types such as roller types and brush type charging devices can be used as the charging devices 5.

The exposing unit 1 is configured as a laser scanning unit (LSU) provided with a laser output portion and reflecting mirror. Arranged in the exposing unit 1 are a polygon mirror that scans a laser beam and optical elements such as lenses and mirrors for guiding the laser beam reflected by the polygon mirror onto the photosensitive drums 3. Furthermore, in addition this, a technique using a writing head in which light-emitting elements such as ELs (electroluminescence) or LEDs (light-emitting diodes) are arranged in an array may be employed as the exposing unit 1.

The exposing unit 1 forms electrostatic latent images corresponding to the image data onto the surfaces of the photosensitive drums 3 by exposing the charged photosensitive drums 3 to light according to the inputted image data.

The toner cartridge units 21 are units that accommodate toner, and are configured to supply toner to a development tank of the developer units 2. In the apparatus main body 110 of the image forming apparatus 100, the toner that is supplied to the development tanks of the developer units 2 from the toner cartridge units 21 is controlled so that the concentration of toner in the developer in the development tanks is uniform.

The developer units 2 use toner of the four colors (K, C, M, and Y) to turn the electrostatic latent images formed on the photosensitive drums 3 into manifest images. Furthermore, the photosensitive member units 4 also have a cleaning function of removing and recovering toner that is residual on the surface of the photosensitive drums 3 after development and image transfer.

The intermediate transfer belt unit 6 positioned above the photosensitive drums 3 is provided with an intermediate transfer belt 61, which acts as an intermediate transfer member, a drive roller 62, an idler roller 63, multiple intermediate transfer rollers 64, and a cleaning unit 65.

Four intermediate transfer rollers 64 are provided corresponding to the colors Y, M, C, and K. An intermediate transfer belt 61 spans in a tensioned state over the drive roller 62 as well as the idler roller 63 and the intermediate transfer rollers 64, and due to rotational drive the intermediate transfer belt 61 circles in a movement direction (the arrow M direction in FIG. 1) and accompanying this the idler roller 63 and the intermediate transfer rollers 64 are idly driven.

A transfer bias for transferring the toner images formed on the photosensitive drums 3 to the intermediate transfer belt 61 is applied to each of the intermediate transfer rollers 64.

The intermediate transfer belt 61 is arranged so as to contact each of the photosensitive drums 3. A color toner image (multicolor toner image) becomes formed on the surface of the intermediate transfer belt 61 by the toner image of each color formed on the photosensitive drums 3 being superimposed and transferred successively. The intermediate transfer belt 61 is configured for example as an endless shape using a film of a thickness in a range of 100 μm to 150 μm.

Transfer of the toner images from the photosensitive drums 3 to the intermediate transfer belt 61 is carried out by the intermediate transfer rollers 64 that are in contact with the rear side of the intermediate transfer belt 61. A high voltage transfer bias (a high voltage that has opposite polarity (+) to the charge polarity (−) of the toner) is applied to the intermediate transfer rollers 64 to achieve transfer of the toner images. The intermediate transfer rollers 64 are rollers based on a metal shaft (for example stainless steel) with a diameter of 8 to 10 mm and the surface thereof is covered by a conductive elastic material (for example, EPDM (ethylene-propylene-diene monomer rubber) or a resin material such as foam urethane or the like). With this conductive elastic material, the intermediate transfer rollers 64 are configured as transfer electrodes that uniformly apply a high voltage to the intermediate transfer belt 61. In the present embodiment, roller shaped transfer electrodes are used as the transfer electrodes, but it is also possible to use other transfer electrodes such as brushes.

As mentioned earlier, the toner images that are made as manifest images according to each hue on the photosensitive drums 3 are layered onto the intermediate transfer belt 61. Due to the orbital movement of the intermediate transfer belt 61, the toner image that is layered onto the intermediate transfer belt 61 is transferred onto the recording paper by a transfer roller 10, which constitutes a secondary transfer mechanism portion arranged at a contact position between the recording paper and the intermediate transfer belt 61. Note however that the configuration of the secondary transfer mechanism portion is not limited to a transfer roller and it is also possible to use a transfer configuration such as a corona charger or a transfer belt.

At this time, while a transfer nip is formed between the transfer roller 10 and the intermediate transfer belt 61, a voltage (a high voltage that has an opposite polarity (+) to the charge polarity (−) of the toner) is applied to the transfer roller 10 in order for the toner to be transferred to the recording paper. The transfer nip is formed between the transfer roller 10 and the intermediate transfer belt 61 by the transfer roller 10 and the drive roller 62 pressing against each other. To obtain a regular transfer nip, either one of the transfer roller 10 or the drive roller 62 is configured as a hard roller constituted by a hard material (metal or the like), while the other is configured as an elastic roller constituted by a soft material (a resin material such as an elastic rubber or a foam resin or the like).

Sometimes toner is residual on the intermediate transfer belt 61 without being transferred to the recording paper when the toner image is transferred to the recording paper from the intermediate transfer belt 61 by the transfer roller 10. Toner that is residual on the intermediate transfer belt 61 is a factor in causing mixed colors of toner at subsequent processes. For this reason, the toner that is residual on the intermediate transfer belt 61 is removed and recovered by the cleaning unit 65. Specifically, the cleaning unit 65 is provided with a cleaning member (for example, a cleaning blade) that makes contact with the intermediate transfer belt 61. The idler roller 63 supports the intermediate transfer belt 61 from the inner side (rear side), and the cleaning member touches the intermediate transfer belt 61 so as to apply pressure from the outer side toward the idler roller 63.

Here, the pre-transfer charging unit 8 has a pre-transfer charger (PTC), and is arranged near the intermediate transfer belt 61 on an upstream side from the transfer nip between the transfer roller 10 and the intermediate transfer belt 61 and a downstream side from the photosensitive member units 4 in the movement direction M of the intermediate transfer belt 61.

In this regard, the toner image on the intermediate transfer belt 61 transferred from the photosensitive drums 3 may include halftone areas and solid areas and may contain areas having varying amounts of layered toner, and therefore sometimes the charge amounts will be uneven. Furthermore, due to a separating discharge produced at a gap on the downstream side near the primary transfer portions in the movement direction M of the intermediate transfer belt 61, sometimes there are uneven charge amounts within the toner image on the intermediate transfer belt 61 after primary transfer. Unevenness such as this in the charge amounts within the same toner image undesirably decreases the margin of transfer when transferring the toner image on the intermediate transfer belt 61 to the sheet.

For this reason, the pre-transfer charging unit 8 is used to uniformly charge the toner image prior to transfer to the sheet, thereby eliminating unevenness in the charge amounts within the same toner image, and making it possible to improve the margin of transfer in secondary transfer.

The paper feed tray 81 is a tray for accommodating in advance the recording papers on which image forming (printing) is to be performed and is arranged under the exposing unit 1 of the apparatus main body 110. Furthermore, recording papers on which image forming (printing) is to be performed are placed in the manual paper feed tray 82. The discharge tray 91 is arranged above the image forming portion 102 of the apparatus main body 110, and recording papers on which image forming (printing) has been completed are stacked face down.

Furthermore, a paper transport path S is provided in the apparatus main body 110 for sending the recording papers that have been sent from the paper feed tray 81 and the manual paper feed tray 82 to the discharge tray 91 via the transfer roller 10 and the fixing unit 7. In the vicinity of the paper transport path S are arranged pickup rollers 11a and 11b, multiple transport rollers 12a to 12d, registration rollers 13, the transfer roller 10, and a heat roller 71 and pressure roller 72 of the fixing unit 7.

The transport rollers 12a to 12d are small-size rollers for facilitating and assisting the transport of recording papers and are provided along the paper transport path S. Furthermore, the pickup roller 11a is provided near the paper feeding side of the paper feed tray 81 and feeds recording papers sheet by sheet to the paper transport path S by picking up the recording papers from the paper feed tray 81. Similarly, the pickup roller 11b is provided near the paper feeding side of the manual paper feed tray 82 and feeds recording papers sheet by sheet to the paper transport path S by picking up the recording papers from the manual paper feed tray 82.

Furthermore, the registration rollers 13 temporarily hold the recording papers that are transported in the paper transport path S. Then, the registration rollers 13 transport the recording papers to the transfer roller 10 with a timing at which a leading edge of the toner image on the photosensitive drum 3 is matched to a leading edge of the recording paper.

The fixing unit 7 fixes the unfixed toner image onto the recording paper and is provided with the heat roller 71 and the pressure roller 72, which act as fixing rollers. By being rotationally driven, the heat roller 71 transports the recording paper while sandwiching the recording paper between itself and the pressure roller 72, which is idly rotated. Furthermore, the heat roller 71 is heated by an internally provided heater 71a and is maintained at a predetermined fixing temperature based on a signal from a temperature detector 71b. Along with the pressure roller 72, the heat roller 71 heated by the heater 71a thermally compresses the multicolor toner image that is transferred to the recording paper onto the recording paper, thereby melting, mixing, and pressuring the multicolor toner image onto the recording paper to perform thermal fixing. Furthermore, an external heating belt 73 is provided in the fixing unit 7 for externally heating the heat roller 71.

In the thus configured image forming apparatus 100, when single sided printing is requested for the recording paper, the recording paper that is fed from the paper feed tray 81 and the manual paper feed tray 82 is transported up to the registration rollers 13 by the transport rollers 12a arranged along the paper transport path S then transported by the transfer roller 10 with a timing at which the leading edge of the recording paper is matched to the leading edge of the toner image on the intermediate transfer belt 61, thereby transferring the toner image onto the recording paper. After this, unfixed toner on the recording paper is melted and affixed thermally by passing through the fixing unit 7, and the recording paper is discharged via the transport rollers 12b to the paper discharge tray 91.

Furthermore, when double sided printing is requested for the recording paper, the recording paper is guided to the transport rollers 12c and 12d by the reverse rotation of the transport roller 12b when the trailing edge of the recording paper, on which the aforementioned single sided printing has been completed and has passed through the fixing unit 7, is positioned between the final transport roller 12b and a branching portion Sa of the paper transport path S. Then, after printing has been performed on the rear surface of the recording paper, which has been transported to the transfer nip through the registration rollers 13, the recording paper is discharged to the discharge tray 91.

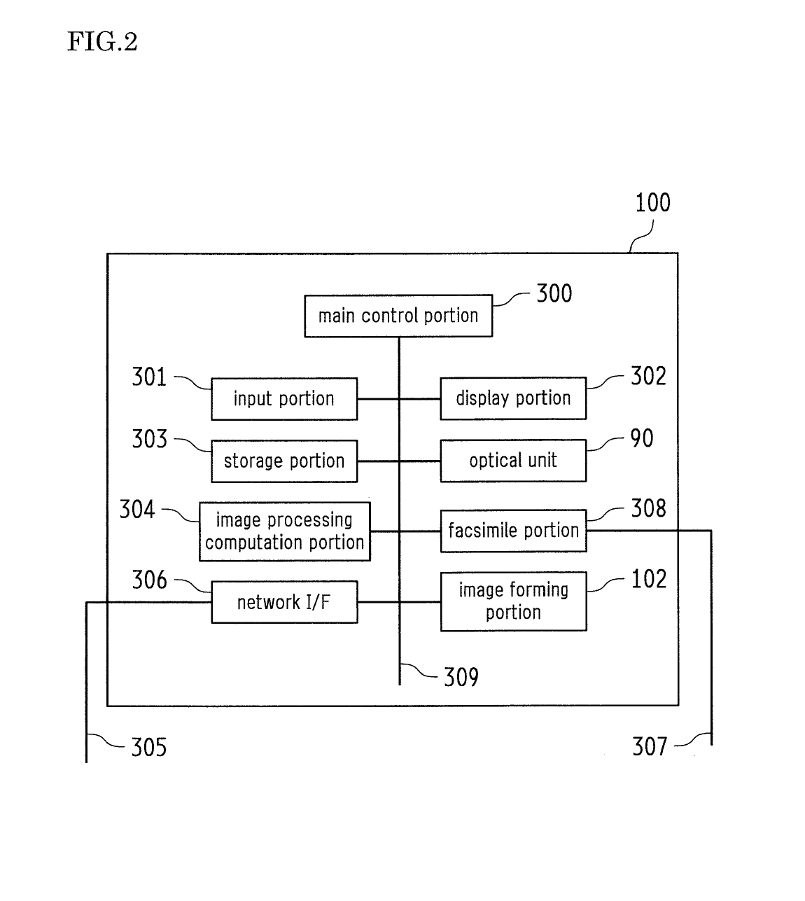

The image forming apparatus 100 according to the present embodiment having the configuration described above is constituted by the main constitutional members shown in FIG. 2, and is provided with a main control portion 300 that carries out control of the various operations of the image forming apparatus 100, an input portion 301 (one portion of the input device 400 of the present invention) by which input operations are carried out directly by the user, a display portion 302 that carries out display of information such as images and the like, a storage portion 303 that stores image data and the like, an image processing computation portion 304 that carries out computation for image processing, a network interface 306 (network I/F) for external connections via a network 305, an optical unit 90 for scanning originals, an image forming portion 102 that forms an image of the original on the recording paper, and a facsimile portion 308 that connects externally via a phone line 307 (performs faxing), and each of these constitutional members is connected so as to be capable of sending and receiving image data (signals) via a bus 309.

The main control portion 300 controls the input portion 301, the display portion 302, the storage portion 303, the image processing computation portion 304, the network interface 306, the optical unit 90, the image forming portion 102, and the facsimile portion 308. For example, the main control portion 300 causes the image forming portion 102 to execute print processing (image forming processing) according to image data received through the network interface 306. Furthermore, the main control portion 300 causes the facsimile portion 308 to execute processing for sending a fax in which image data targeted for sending is sent by calling a telephone number of a specified destination. Furthermore, the main control portion 300 causes the optical unit 90 to execute processing for scanning by reading an image formed on an original. In this way, the main control portion 300 causes various operations to be executed by the constitutional members of the image forming apparatus 100 based on input such as input from the input portion 301, external input through the network interface 306, and external input through the facsimile portion 308.

The input portion 301 is a portion for inputting information, and the display portion 302 is a portion for displaying arbitrary information including image information, and the input device 400 described below is constituted by the input portion 301 and the display portion 302. It should be noted that a liquid crystal display device may be set forth as an example of the input portion 301 and the display portion 302. The storage portion 303 is a readable/writable large capacity nonvolatile memory that stores image data obtained by reading an original or image forming processing data as required when image forming processing is performed on image data.

The image processing computation portion 304 is constituted by specialized signal processing circuits and the like, and carries out various types of image processing based on image data, and carries out conversion processing such as converting image data to various types of data (such as bitmap image data) and generation processing of image data to be sent to external devices (for example, image data that is to undergo predetermined encoding such as a JPEG format or the like).

The network interface 306 is a communications interface for carrying out the exchange of data (including image data) between external information processing terminals and external devices through a network 305 constituted for example by a LAN conforming to a standard such as IEEE 802.3 and the Internet.

The optical unit 90 is a color scanner that reads an image formed on an original placed on the original placement platform 92 or an original transported by the original reading device 108.

The image forming portion 102 is a so-called image forming engine that is controlled by the main control portion 300, and is a collection of components such as devices that form (output) an image on recording paper in image forming positions based on image data of an original and image data for printing and an MPU or the like that controls these devices. The facsimile portion 308 is provided with a communications means such as a modem or the like and carries out exchanges of data (including image data) between external fax machines and external information terminal devices and the like through a telephone line 307. It should be noted that in the present embodiment the facsimile portion 308 and the network interface 306 are configured as separate constitutional members, but there is no limitation to this, and these may be configured as a single external communications member as a member for carrying out external data exchanges.

Input Device of Image Forming Apparatus

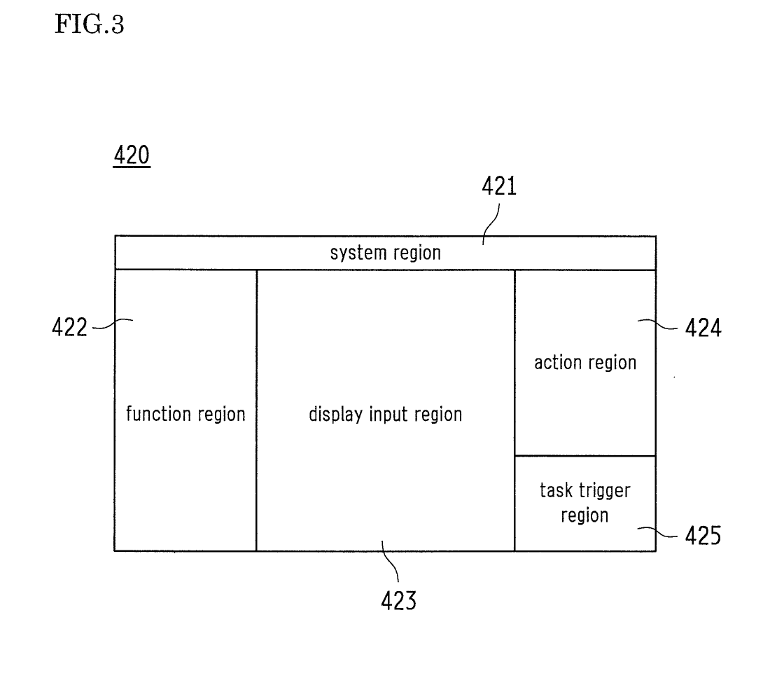

In the image forming apparatus 100 constituted as described above, the input device 400 shown in FIG. 5 for the user to carry out input through touch operations is arranged at an upper area of the apparatus main body 110 (near the optical unit having the reference symbol 90 shown in FIG. 1). The input portion 301 and the display portion 302 shown in FIG. 2 are provided in the input device 400 and constitute a man-machine interface for the user. Hereinafter description is given regarding the input device 400 using FIGS. 3 to 6.

As shown in FIG. 5, the input device 400 has a display portion 411, and a touch panel system panel portion 410 is provided by which input (external input) is carried out by the user touching the display portion 411. The panel portion 410 is designed such that at least one area of the panel portion 410 is displaced due to touch by the user.

The display portion 411 of the panel portion 410 is constituted by a layered structure in which a touch panel 413, by which electrical input is carried out due to touch by the user, is layered over a liquid crystal panel 412 that outputs display screens 420 shown in FIGS. 3 to 6. The panel portion 410 is a component that enables selection or execution of an item due to the user pressing his or her finger on an input region of the touch panel 413 corresponding to the item displayed on the display screen 420.

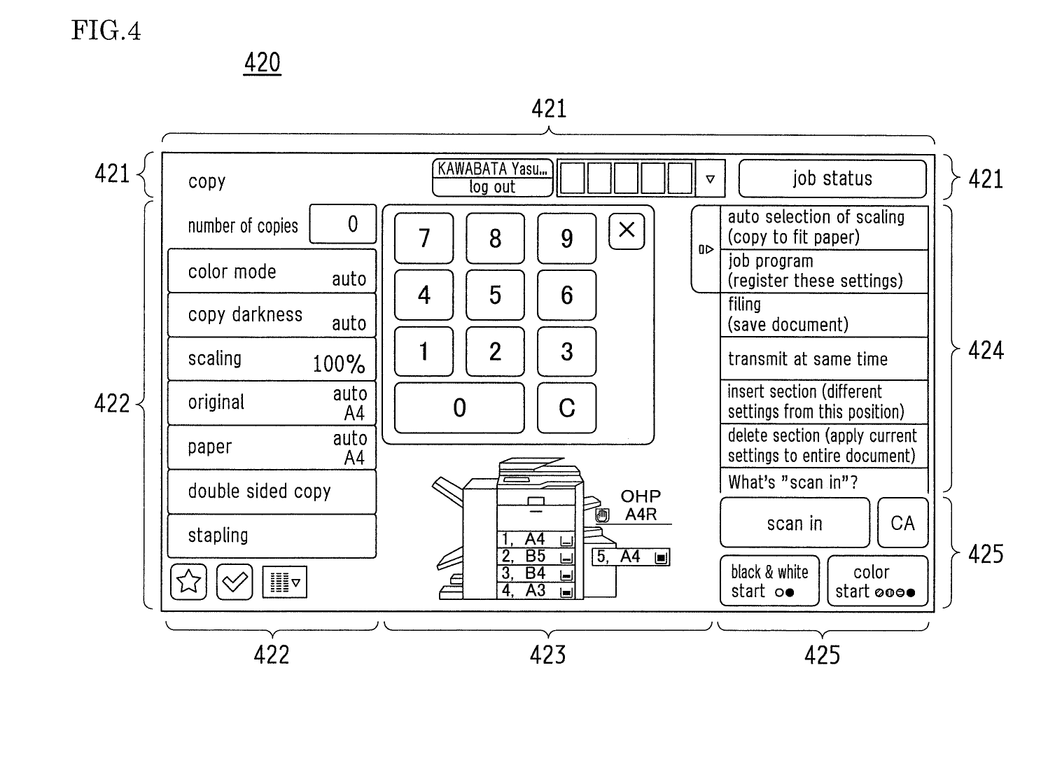

As shown in FIGS. 3 and 4, the display screen 420 of the panel portion 410 is constituted by five regions, these being a system region 421, which displays the current operational mode and current user and job status and the like, a function region 422, in which function settings and function confirmations are carried out, a display input region 423, in which previews and numerical input and the like are carried out, an action region 424, in which various operations are selected or registered, and a task trigger region 425, in which execution operations relating to image forming are commenced. It should be noted that FIG. 3 is an outline configuration drawing of the display screen 420 showing positions of the system region 421, the function region 422, the display input region 423, the action region 424, and the task trigger region 425 on the display screen 420 of the panel portion 410. Furthermore, FIG. 4 is an outline configuration drawing of the display screen 420 showing each item in the system region 421, the function region 422, the display input region 423, the action region 424, and the task trigger region 425 relating to the present embodiment.

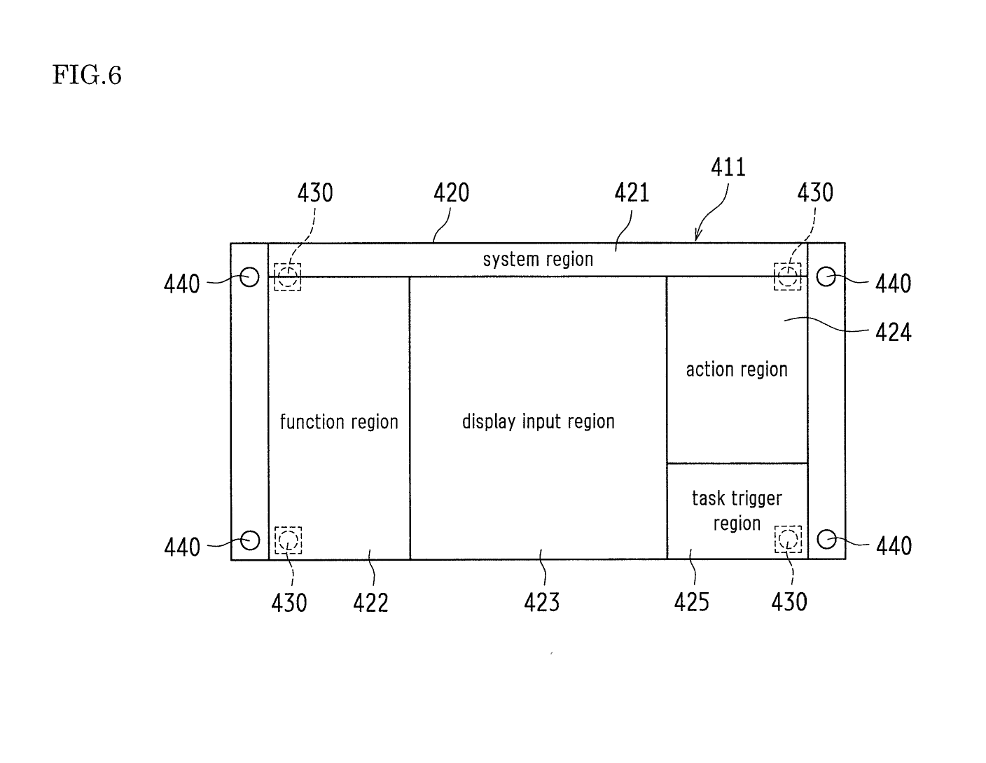

Furthermore, in the input device 400, as shown in FIGS. 5 and 6, four switch portions 430 are arranged directly below the four corners of the panel portion 410 (specifically, the liquid crystal panel 412), which is formed in a planar view rectangular shape, and these four switches 430 are provided on top of a flat panel member 441. These four switch portions 430 operate independently and operate according to displacement exceeding a preset displacement amount of the panel portion 410. It should be noted that in the display screen 420 shown in FIG. 6, of the four switch portions 430, only the switch portion 430 arranged at the lower right in FIG. 6 is set so as to operate, and the other switch portions 430 are set so as to not operate. That is, control is performed by the main control portion 300 so that only the switch portion 430 directly below the task trigger region 425 shown in FIG. 6 operates.

It should be noted that each region in the display screen 420 according to the embodiment described above is not fixed in the arrangement shown in FIG. 6 and can be set arbitrarily. Thus, display control is performed by the main control portion 300 such that the arrangement of each of the regions is variable so that, for example, by reversing all the regions left and right, the function region 422 is arranged on the right side and the action region 424 and the task trigger region 425 are arranged on the left side. In regard to this modified example, control is performed by the main control portion 300 so that the operable switch portion 430 is varied so as to be arranged directly below or near to directly below the task trigger region 425.

As described above, in the present embodiment, control is performed by the main control portion 300 so that only the switch portion arranged directly below or near to directly below the task trigger region 425 operates.

The four switch portions 430 are constituted by equivalent members and as shown in FIGS. 5 and 6, pressable button portions 432 are set on pedestal portions 431 so as to resist and be biased in a pressure direction (downward direction in FIG. 5) by pressure on the panel portion 410. For this reason, when there is no pressure from the panel portion 410, the button portions 432 are in a state of maximum protrusion from the pedestal portions 431 (a state protruding vertically upward in FIG. 5).

Furthermore, stopper portions 433 are provided at the switch portions 430 to protect the switch portions 430 by restricting displacement of the panel portion 410 closer toward the switch portions 430, and the amount of displacement of the panel portion 410 is preset (restricted) by these stopper portions 433.

Furthermore, as shown in FIGS. 5 and 6, each of the switch portions 430 is provided near one of four support props 440 that support the panel portion 410. At the four corners of the panel portion 410, the support props 440 are provided inserting into pass-through holes 414 formed in the four corners of the panel portion 410, and the panel portion 410 readily displaces in the direction in which the support props 440 are erected due to the touch of a user onto the panel portion 410. Here, as mentioned above, the displacement amount of the panel portion 410 is determined by the stopper portions 433 of the switch portions 430. For this reason, damage (cracking or the like) of the panel portion 410 due to displacement of the panel portion 410 is prevented by the stopper portions 433.

In the input device 400 of the above-described configuration, input from outside (touch input by the user) is carried out based on input operations at the panel portion 410 and input operations at the switch portions 430. Input according to the present embodiment includes a first input, in which input is performed using only the panel portion 410 with no input using the switch portions 430, and a second input, in which input is performed using the panel portion 410 and the switch portions 430, and these first input and second input are controlled by the main control portion 300. Specifically, the main control portion 300 carries out detection of the first input in which input is performed using only the panel portion 410 and detection of the second input in which input is performed using the panel portion 410 and the switch portions 430. Here, the target of the first input is each of the items in the system region 421, the function region 422, the display input region 423, and the action region 424, and the target of the second input is each of the items of the task trigger region 425.

With the input device 400 and the image forming apparatus 100 according to the present embodiment, an input click sensation can be achieved even with input using the panel portion 410. In particular, with the present embodiment, since there is the first input, which is input carried out using only the panel portion 410, and the second input, which is input carried out using the panel portion 410 and the switch portion 430, input that requires a click sensation and input that does not require a click sensation can be carried out with a single input device 400, which increases the degree of freedom of the input device 400. Furthermore, since the first input and the second input can be used in combination, it is possible to differentiate input for commencing execution and operation relating to image forming (input to each item of the task trigger region 425) and input for selecting operations other than these, and by implementing an input click sensation in regard to only input for commencing execution and operation relating to important image forming, this is effective also for the user in confirming execution and operation.

Furthermore, the switch portion 430 is arranged directly below or near to directly below the input region of the second input (the task trigger region 425) of the display portion 411, and therefore the second input can be carried out easily, and moreover it is possible to inhibit inadvertent operations of the first input and the second input.

Furthermore, the switch portions 430 are provided at the four corners of the display portion 411, and the input target for the second input is input using the panel portion 410 and the switch portions 430 provided at the four corners, and therefore it is possible to reduce the pressing force by which the user touches the display portion 411 for carrying out the second input. This is related to the fact that the pressing force required to displace the panel portion 410 by pressing the edge areas (the four corners in the present embodiment) is smaller than the pressing force required to displace the panel portion 410 by pressing, for example, a central area of the panel portion 410.

Furthermore, stopper portions 433 are provided at the switch portions 430 and therefore displacement of the panel portion 410 can be restricted by the stopper portions 433, which enables damage (cracking or the like) of the panel portion 410 to be prevented. Furthermore, the force of the panel portion 410 pressing the switch portions 430 can be concentrated on the stopper portions 433 such that breakage of the switch portions 430 due to pressing of the panel portion 410 can be suppressed.

It should be noted that in the present embodiment four switch portions 430 are provided, but the number of switch portions 430 is not limited to this.

Furthermore, in the present embodiment, the four switch portions 430 are provided directly below the four corners of the panel portion 410 respectively, but there is no limitation to this and any of these may be provided at an edge area of the panel portion 410 directly below or near to directly below an input region of the second input (the task trigger region 425 in the present embodiment) of the display portion 411.

Furthermore, in the present embodiment, the switch portions 430 and the support props 440 are configured as separate members, but the switch portions 430 may be appended to the support props 440.

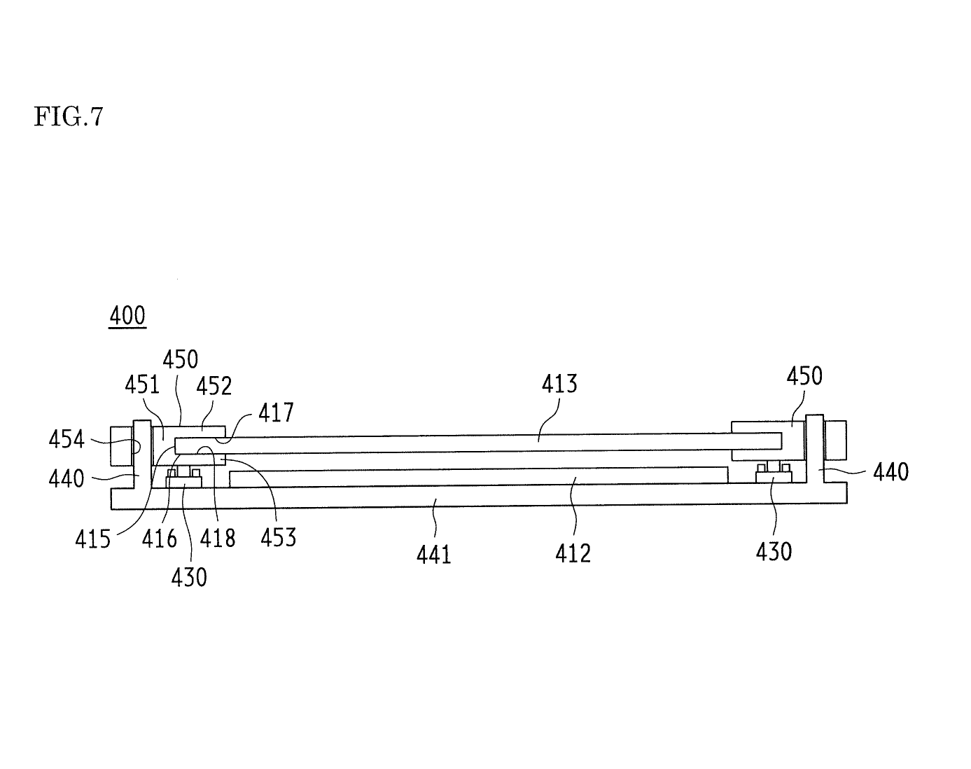

Furthermore, in the present embodiment, the support props 440 are provided inserting into pass-through holes 414 formed in the panel portion 410 as a structure to support the panel portion 410, but there is no limitation to this and, for example, as shown in FIG. 7, this may be a structure in which the panel portion 410 is fitted into coupling portions 450 so that outer circumferential edges 416 of the panel portion 410 are covered and the support props 440 are provided such that the coupling portions 450 readily displace.

In the input device 400 shown in FIG. 7, the coupling portions 450 are provided fitting the touch panel 413 so as to cover the outer circumferential edges of the touch panel 413. The coupling portions 450 are integrally formed having a lateral wall portion 451 that covers a lateral surface 415 of the touch panel 413, and a front wall portion 452 and a rear wall portion 453 that cover front and rear surfaces 417 and 418 of the outer circumferential edges 416 and a vicinity thereabout of the touch panel 413. Furthermore, pass-through holes 454 are provided at the coupling portions 450 in which are inserted the support props 440. In the input device 400 shown in FIG. 7, the coupling portions 450 in which the touch panel 413 is fitted displace in a pressing direction (downward direction in FIG. 7) due to input to the touch panel 413 from outside (touch input by the user), and input is carried out according to the first input and the second input. It should be noted that in the input device 400 shown in FIG. 7, the liquid crystal panel 412 is arranged on top of the flat panel member 441 in which the support props 440 are provided.

It should be noted that color image forming apparatuses according to the present invention shown as examples of the present embodiment also can be applied to image forming apparatuses such as copiers, printers, and fax machines.

Furthermore, the present invention can be embodied and practiced in other different forms without departing from the spirit, purport or essential characteristics thereof. Therefore, the above-described embodiments are considered in all respects as illustrative and not restrictive. The scope of the invention is indicated by the appended claims rather than by the foregoing description. All variations and modifications falling within the equivalency range of the appended claims are intended to be embraced therein.

Furthermore, the present invention is effective in color image forming apparatuses.

The present invention can be embodied and practiced in other different forms without departing from the spirit, purport or essential characteristics thereof. Therefore, the above-described embodiments are considered in all respects as illustrative and not restrictive. The scope of the invention is indicated by the appended claims rather than by the foregoing description. All variations and modifications falling within the equivalency range of the appended claims are intended to be embraced therein.

What is claimed is:

1. An input device of an image forming apparatus, comprising:
a panel portion having a display portion and by which input is carried out by a user touching the display portion, and in which at least one portion is displaced according to touch by the user, and
at least one switch portion by which input is carried out by an operation according to displacement exceeding a preset displacement amount of the panel portion,
wherein input by the input device includes a first input, which is input carried out using only the panel portion, and a second input, which is input carried out using the panel portion and the switch portion.

2. The input device according to claim 1,
wherein the switch portion is arranged directly below or near to directly below an input region of the second input of the display portion.

3. The input device according to claim 1,
wherein the at least one of the switch portions is provided at an edge area of the display portion, and
the second input is input using the panel portion and the switch portion that is provided at the edge area.

4. The input device according to claim 1,
wherein a stopper portion is provided at the switch portion to protect the switch portion by restricting displacement of the panel portion closer toward the switch portion.

5. An image forming apparatus, comprising:
an input device according to claim 1.
